(19) United States
(12) Patent Application Publication
(10) Pub. No.: US 2013/0036062 A1
(43) Pub. Date: Feb. 7, 2013

(54) SYSTEM AND METHOD FOR IMPROVING CUSTOMER SERVICE EFFICIENCY

(71) Applicants: Swaminathan Natarajan, Bangalore (IN); Komal Kachru, Bangalore (IN); Venugopal Subbarao, Bangalore (IN); Sujith Joseph, Erumelikara (IN)

(72) Inventors: Swaminathan Natarajan, Bangalore (IN); Komal Kachru, Bangalore (IN); Venugopal Subbarao, Bangalore (IN); Sujith Joseph, Erumelikara (IN)

(73) Assignee: INFOSYS LIMITED, Bangalore (IN)

(21) Appl. No.: 13/344,603

(22) Filed: Jan. 5, 2012

(30) Foreign Application Priority Data
Aug. 1, 2011 (IN) 2633/CHE/2011

(51) Int. Cl. G06Q 10/00

(52) U.S. Cl. 705/304

(57) ABSTRACT

The disclosed embodiments relate to a method for improving customer service efficiency. The method preferably comprises receiving information from a customer, identifying an issue based on the information received from the customer, and determining, by a computing device, whether a solution resolving the identified issue exists in a knowledge database that associates customer issues with known solutions, wherein the knowledge database includes information based on historical data, expert knowledge, one or more diagnostic techniques, and one or more language models. The disclosed embodiment also relates to a system and computer-readable code that can be used to implement the exemplary methods.

### RELATED APPLICATION DATA

This application claims priority to Indian Patent Application No. 2633/CHE/2011, filed Aug. 1, 2011, which is hereby incorporated by reference in its entirety.

### FIELD OF THE INVENTION

The invention relates to a system and method for improving customer service efficiency.

### BACKGROUND

Customer satisfaction is an important metric that needs to be tracked by any company. To have a satisfied customer is not an easy task, especially when a customer calls the company's support center to report a problem that they are facing in the product or services that they bought from the company. Traditionally, call centers employ a knowledge management process to identify and resolve customer problems. Any call center trouble shooting environment typically has pre-defined steps to follow, in order to diagnose the fault and suggest remedy. The traditional approaches of sequentially following pre-scripted troubleshooting steps to arrive at the resolution of a problem are non optimized and lengthy procedures. In addition, traditional systems are totally expert knowledge driven, and traditional systems are static and involve enormous amount of human effort to update them.

As is shown in FIG. 1, traditional customer support centers deploy knowledge management processes to try and provide a quick and correct solution to the customer, but this approach usually fall woefully short of achieving the objective. Typically, usually the call centre consists of knowledge artifacts where the knowledge is captured and managed to support all the processes. These artifacts are essentially in the form of scripted steps to be followed, every time a call with a particular issue comes. The disadvantages well-known with this approach/methodology are many. The foremost is that the information that the customer provides is not sequential. For example, the customer may give the observations related to the issue in a random process. Since the resolve mechanism here is a scripted set of step-wise processes or tests, the drill down from observations to identifying the issue, to reaching to a resolve tends to get tedious both for the customer and the customer service representative.

Additionally, the scripted approach does not provide any flexibility to the customer service representative. The system once deployed does not leverage the knowledge or experience gained out of all the calls received and their respective resolve history. Eventually, it ends up in longer time and sometimes inconclusive resolve. Additionally it results in lower call resolution throughput of the customer service representative and higher escalations to the next level. Also the expertise of the customer service representative handling the call plays a key role. A novice customer service representative is completely dependent on the system for the troubleshooting.

### SUMMARY

The disclosed embodiment relates to a method for improving customer service efficiency. The method preferably comprises receiving information from a customer, identifying an issue based on the information received from the customer, and determining, by a computing device, whether a solution resolving the identified issue exists in a knowledge database that associates customer issues with known solutions, wherein the knowledge database includes information based on historical data, expert knowledge, one or more diagnostic techniques, and one or more language models. If a solution to the identified issue exists in the knowledge database, the solution can be reported to the customer. If a solution to the identified issue does not exist in the knowledge database, the method preferably comprises determining an alternative solution based the information received from the customer, determining whether the alternative solution resolves the identified issue, and, if the alternative solution resolves the identified issue, updating, by a computing device, the knowledge database to associate the identified issue with the alternative solution.

The disclosed embodiment further relates to a system for improving customer service efficiency. The system comprises a computing device configured to receive information from a customer, a computing device configured to identify an issue based on the information received from the customer, a computing device configured to determine whether a solution resolving the identified issue exists in a knowledge database that associates customer issues with known solutions, wherein the knowledge database includes information based on historical data, expert knowledge, one or more diagnostic techniques, and one or more language models, a computing device configured to report a solution to the customer if the solution to the identified issue exists in the knowledge database, a computing device configured to determine an alternative solution based the information received from the customer if a solution to the identified issue does not exist in the knowledge database, a computing device configured to determine whether the alternative solution resolves the identified issue if a solution to the identified issue does not exist in the knowledge database, and a computing device configured to update the knowledge database to associate the identified issue with the alternative solution if the alternative solution resolves the identified issue.

Furthermore, the disclosed embodiment relates to computer-readable code stored on a non-transitory computer-readable medium that, when executed by a mobile device, performs a method for improving customer service efficiency. The method preferably comprises receiving information from a customer, identifying an issue based on the information received from the customer, and determining, by a computing device, whether a solution resolving the identified issue exists in a knowledge database that associates customer issues with known solutions, wherein the knowledge database includes information based on historical data, expert knowledge, one or more diagnostic techniques, and one or more language models. If a solution to the identified issue exists in the knowledge database, the solution can be reported to the customer. If a solution to the identified issue does not exist in the knowledge database, the method preferably comprises determining an alternative solution based the information received from the customer, determining whether the alternative solution resolves the identified issue, and, if the alternative solution resolves the identified issue, updating, by a computing device, the knowledge database to associate the identified issue with the alternative solution.

The disclosed embodiments also provide that the diagnostic techniques may utilize a knowledge model based on information obtained through the use of a Bayesian model, a neural network, a decision tree approach, and the like. The information within the knowledge database may also be organized into one or more classifications. The historical data may include information based on issues previously identified and the effectiveness of any solutions applied to the previously identified issues. Moreover, computer-executable code may be developed based on the knowledge database.

### BRIEF DESCRIPTION OF THE DRAWINGS

FIG. 1 illustrates a traditional customer call center dynamic.

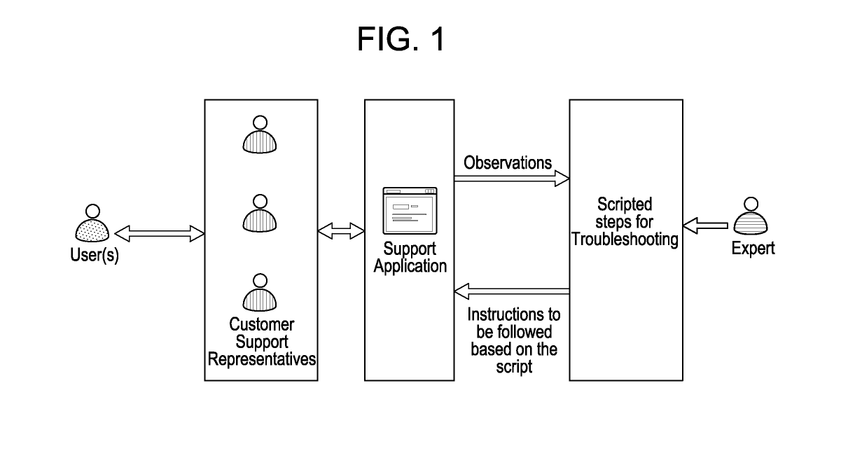

FIG. 2 illustrates an exemplary system according to the disclosed embodiment

FIG. 3 is a flowchart illustrating an exemplary customer service representative troubleshooting process according to the disclosed embodiment.

FIG. 4 illustrates an exemplary predictive analytics approach according to the disclosed embodiment.

FIG. 5 illustrates an exemplary computing device useful for implementing systems and performing methods disclosed herein.

### DETAILED DESCRIPTION

The disclosed embodiments relate to diagnosing and optimizing the entire issue resolve process in a customer service (i.e. call center) environment. This disclosed embodiment aids in increasing the quality of experience of a customer who calls the customer care with certain issues he is facing with the company product or services. It also eases the pressures of a customer service representative who has to resolve the problem based on the customer and system generated inputs. Specifically, the disclosed embodiments provide a systematic and sequential approach to resolving customer problems utilizing a set of models which encodes the knowledge required to solve problems, methods for identifying ordered set of probable issues based on symptoms observed, knowledge creation methods, diagnostic methods to guide the customer service representative to quicker resolution of an issue, optimization of troubleshooting to find the cause of issue, and, once the cause has been identified, a set of steps or procedure to arrive at the fix for the cause or to decide further on escalation. The disclosed embodiments also utilize a self-learning approach which updates the system over time and usage.

Thus, the disclosed embodiment optimizes troubleshooting in a customer service or call center environment. Traditional systems are expert driven and static, and require human intervention for any modification or up gradation. This results in a long wait for the agent to get system with modified knowledge base. For example, traditional systems require the use of non-optimized approaches to assist an agent to address customer problems.

The disclosed embodiment addresses shortcomings of existing systems by combining traditional approaches with techniques from predictive analytics, and enabling automatic up gradation of the system. The disclosed embodiment introduces the concept of self leaning in optimizing the whole of fault diagnosis process at different stages of trouble shooting. The system has a provision to record all the steps in an issue resolution process and uses them in building and upgrading the knowledge base. Thus, the system gains experience with time and usage, and is dynamic.

The disclosed embodiment further provides a system and method for complete and optimized issue resolving process in a call center environment. The approach is to optimize the existing knowledge artifacts and help customer service representative to find the appropriate knowledge artifacts linked to particular customer's issues. Thereby, trying to resolve customer issues in an optimized manner to achieve faster resolution and better customer satisfaction. This is achieved by optimizing interconnection and assembly of the knowledge artifacts for better diagnosis, capturing an expert's knowledge and experience in form of knowledge models, integrating existing and new knowledge models, utilizing knowledge creation methods and systems to help a domain expert build the knowledge models, leveraging past historic data and events that contribute towards these models and interconnecting different knowledge artifacts for faster fault resolution, recording and storing all the details of the issue resolving process, updating the system periodically based on new data that flows in from the ticketing system for continuous up gradation of system and refinement of issue resolution. Thus, the knowledge models provide effective knowledge retrieval based on the effectiveness of solutions rendered.

The knowledge capturing process combines both expert knowledge and historical data and utilizes domain/product/computing device specific language models and combinations of different diagnostics techniques. The disclosed embodiments further utilize workbench techniques to provide domain/product specific languages for developing diagnostics knowledge base. Exemplary workbench techniques utilize expert based approaches for capturing the domain, and also utilize associated diagnostics knowledge leveraging techniques such as Bayesian models, neural networks, and decision tree approaches, as well as statistics based techniques such as classification. The disclosed workbench also provides code-generation functionalities for generating code from the models.

The disclosed embodiments further achieve the objective by optimizing the pre-scripted steps to identify the cause of an issue, navigating the customer service representative via shortest route to arrive at the solution to the problem, updating the navigation path based on logged tickets, maintaining and updating knowledge models through self-learning by extracting valuable information and trends from the data that continuously flows in the system with its usage, identifying deficiencies of the diagnosis knowledge structures based on the data and suggest changes to the knowledge structure, logging details like “time to resolve” and deciding on escalations, utilizing rules to identify tickets which should not be part of learning system (i.e. Tickets which may deteriorate the accuracy of the system should be excluded in the learning), and utilizing integration mechanisms that allow the system to be connected to external test and diagnose systems.

The disclosed embodiment aids the customer service representative in trying to resolve customer issues in a faster and efficient manner. The overall flow can be explained in three phases, namely build or training phase, troubleshooting phase and self-learning phase.

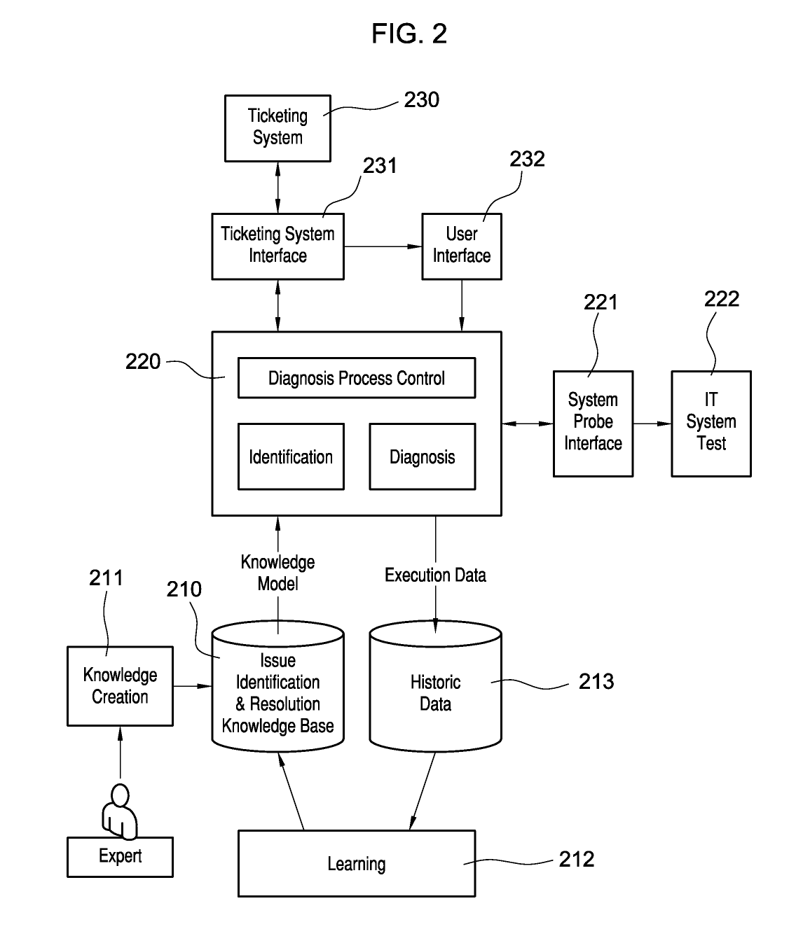

As explained in more detail below, FIG. 2 illustrates the overall system according to the disclosed embodiment. As is shown in FIG. 2, a knowledge database 210 is built using data from experts through knowledge creation 211 and from self-learning 212, which utilizes historical data 213. Knowledge database 210 is in communication with system 220, includes means for diagnosis process control, identification, and diagnosis. System 220 is also in communication with it system tester 222 via system probe interface 221, and ticketing system 230 via ticketing interface 231. A user interface 232 is also utilized.

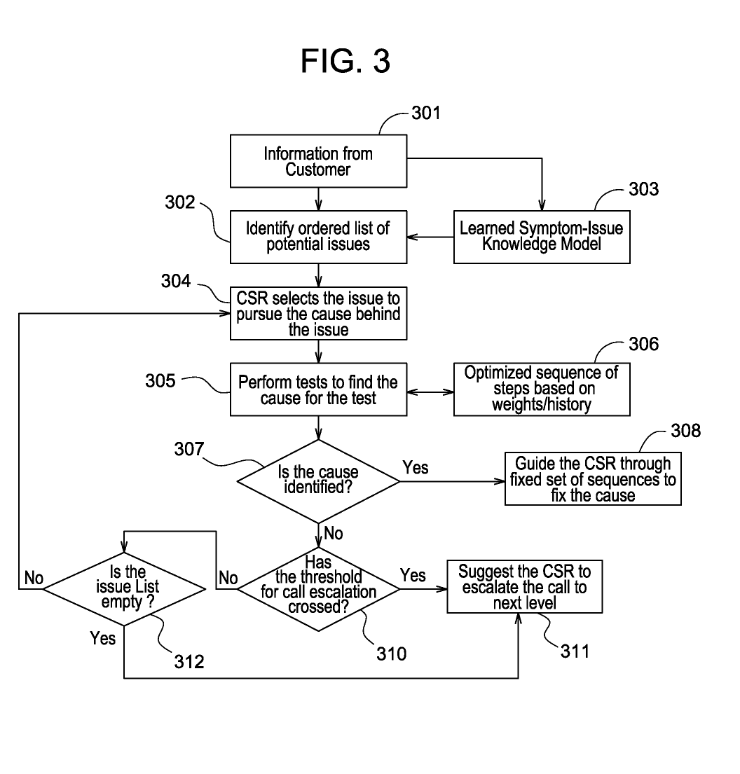

FIG. 3 illustrates a customer service representative troubleshooting process according to the disclosed embodiment. As is shown in FIG. 3, information is received from a customer in step 301. Based on the information, issues are identified in step 302. If necessary, information from learned symptom-issue knowledge model 303 can be utilized. The customer service representative then selects an issue to pursue in step 304. Tests are then performed in step 305, which may utilize existing optimized sequences of steps in step 306. In step 307, it is determined whether the cause of the issue is identified. If so, the customer service representative is guided through steps to fix the issue in step 308. If not, it is determined whether a threshold for issue escalation has been reached in step 310. If so, the customer service representative is suggested to escalate the issue in step 311. If not, it is determined whether any other possible issues remain in step 312. The cycle continues until the issue is identified and resolved.

Build and Train Phase

As illustrated in FIGS. 2 and 3, an expert first identifies a list of faults and their related symptoms or observations. The subject matter expert then proceeds to build a knowledge model which relates the symptoms and faults. The knowledge model can be a Bayesian model, a neural network or any other model which can capture the expert's knowledge and data hidden insights for better inference. The knowledge model identifies the task to be pursued first, thus minimizing the time and effort lost in unnecessary tests. The requirement for knowledge model is that it should be able to model the symptoms and the related faults based on expert or/and past data. The system has the flexibility of integrating different knowledge models which can optimize the process based on expert knowledge or past trends. Two examples of the knowledge model namely, Bayesian models and neural networks that can be incorporated are explained below.

Bayesian Model for Diagnosis

A Bayesian model captures the key issues that can happen in the service and the symptoms that manifest these issues. Bayesian models are graphical probabilistic models that represent a set of variables or nodes and their probabilistic independencies. Bayesian models are directed acyclic graphs, where symptoms and issues are the nodes and their relationships or interdependencies is represented by directed arrows. Domain experts can identify the variables and connects them as per their interdependencies and his experiential knowledge to build the Bayesian model.

Once the Bayesian model is built the subject matter expert can utilize past data to mine the knowledge of the co-relation between the symptoms and issues. The historic data is used to fill conditional probability tables for all the nodes. Thus enabling the knowledge or the data correlation embedded in the historic records to get captured in the form of conditional probability tables of Bayesian model and hence enables futuristic inference. The Bayesian model is used by the customer service representative to diagnose which issue to pursue first.

Neural Networks for Diagnosis

An artificial neural network is an information processing paradigm inspired by the way the densely interconnected, parallel structure of the mammalian brain processes information. Neural networks are collections of mathematical models that emulate some of the observed properties of biological nervous systems and draw on the analogies of adaptive biological learning. Neural networks are composed of large number of processing elements (neurons) working in unison to solve specific problems. The function of a neural network is determined by a network structure, connection strengths and the processing performed at the computing elements or nodes. A neural network is thus a massively parallel-distributed processor that has a natural propensity for storing experimental knowledge and making it available for use.

A subject matter expert identifies the symptoms and faults related to them. Past data is used to learn this input-output pairing, i.e. Symptoms and their related faults. Once the system has learned, it can infer the faults based on the learned model and customer inputs or symptoms he may be facing. The expert can further expert encode the troubleshoot steps to arrive at the cause of the issue. The expert encodes this procedure in form of question-answer or test-result format. Each step in this troubleshoot procedure has a weight function attached to it. This weight function is calculated and updated based on the shortest path used to arrive at the cause in the past. The complete interaction between the customer service representative and customer gets recorded in the system and contributes towards increasing the efficiency of the diagnostic and troubleshoot procedure.

Troubleshooting Phase

After the training phase, the system gets deployed on the server and is ready to use by customer service representatives for troubleshooting. The customer service representative receives a call from the customer who is facing certain issues with the enterprise products or services. Customer service representative opens a new case in this system. Based on the initial inputs given by the customer and the symptom-issue knowledge model, the system identifies an ordered list of potential issues.

The system has two modes including an expert mode and a novice mode. In the case of expert mode, the customer service representative can modify the ordered list of potential issues if he disagree with the potential issues identified. In contrast, a new or trainee customer service representative who uses the tool in novice mode strictly follows the steps suggested by the system.

The customer service representative pursues an issue to identify the underlying cause. The steps to arrive at the cause are optimized based on pre-calculated weights. The weights help in identifying which step to perform next. These steps preferably include a set of questions being asked to the customer or tests conducted to get more information about the problem customer is facing. These weights are calculated based on the maximum frequency of tests conducted and shortest path identified to arrive at the cause of this issue based on past history.

The above steps are iterated until the cause for the issue is identified. After the cause has been identified, the system conducts pre-scripted steps to identify the fault and resolve the same.

If the customer service representative and system are unable to resolve the problem or the threshold for call escalation has been crossed, the particular call may get escalated to next level. The next level could be dispatching a technician to the site or call being handled by another an executive.

Troubleshooting with Predictive Analytics Approach

Predictive analytics has essentially grown from the data mining and statistical fields and uses proven techniques that analyze current and historical data to make predictions about future events. In a typical life-cycle for using predictive analytics, data is collected, a predictive model is formulated, predictions are made and the predictive model is revised as additional data becomes available. Embedding predictive analytics within operational processes is becoming very popular. Enterprises and the information management community are constantly identifying new operational processes that can benefit from predictive analytics. This move essentially stems from a constant drive to improve process efficiency which necessitates analysis to be made and decisions to be taken on the spot by people who are on the job.

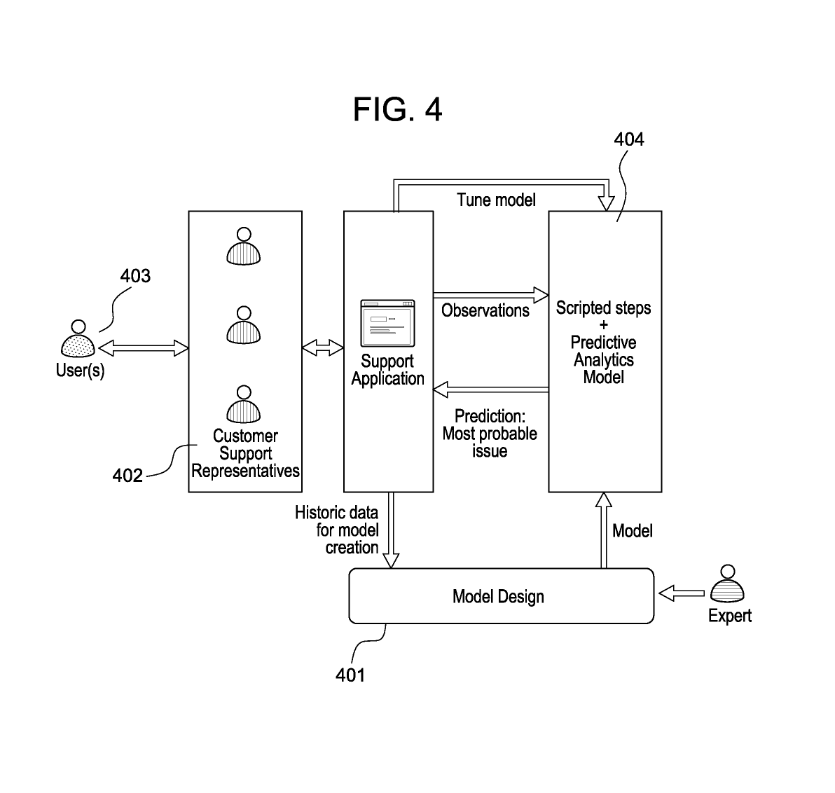

FIG. 4 illustrates an exemplary predictive analytics approach according to the disclosed embodiment. A predictive knowledge model 401 utilizes information hidden in historic records and an expert's knowledge. This model is then used to do real time analytics. The customer service representative 402 feeds the observations received from the customer 403 to the predictive analytics model. Based on the model and the scripted steps 404 for troubleshooting, the customer service representative 402 is provided with the most probable issue to be pursued for the call resolution. It also guides the customer service representative with the optimized flow to be followed for faster and accurate resolution process. The solution enables self-learning, by continuously updating the models with the latest data.

Self-Learning Phase

The disclosed embodiment includes provisions to update the system knowledge and diagnosis based on new data flowing in from the ticketing system. The system periodically recalculates the weights and mathematical matrices which drive the identification and diagnosis in the troubleshooting phase. Each and every call and the complete interaction of each call gets recorded and stored in the systems data store. The system's engine picks this data periodically to recalculate its mathematics and thus keep itself up to date about the changing trends or new information. Thus, self-learning periodically updates the issue identification process based on initial symptoms received and the optimized sequence of steps to arrive at the cause of issue.

As described herein, the disclosed embodiment improves the customer's overall experience, reduces the average time to resolve issues, makes the system dynamic, with minimal time required for up gradation and modification, and aids in training new customer support executives. In contrast to existing systems and methods, the disclosed embodiment provides a dynamic self-learning system while maintaining knowledge in a unique way at different stages by introducing new concepts and also utilizing it optimally to improve on the troubleshooting is not obvious. Thus, the disclosed embodiment provides a unique way of combining the traditional approach with techniques from predictive analytics to better the customer's overall experience in a call center environment, integrating static knowledge assets with live operations data, building, maintaining and utilizing the knowledge in the system, utilizing self-learning to diagnose the issue based on symptoms provided by the customer or test system, and achieving a dynamic recordation of the complete interaction with customer till the resolution and taking insights from this data to enhance the resolution process going forward.

The disclosed embodiment thus reduces the training time and costs for new staff, improves call handing and response times, offers greater consistency and accuracy of information provided to customers, enables greater flexibility in handling changing business processes, products, and information, and reduces the escalations of calls to second-level support or the help desk.

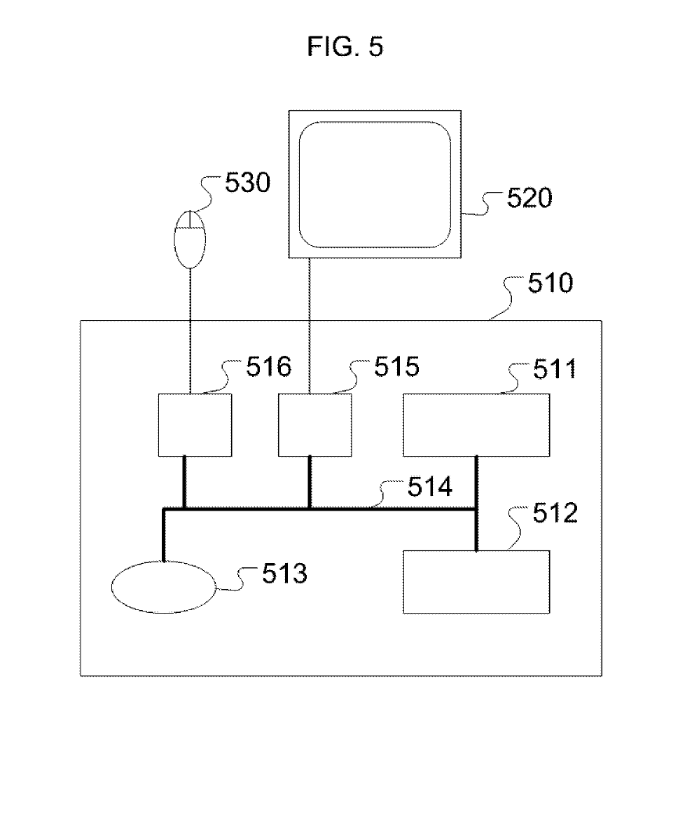

The embodiments described herein may be implemented with any suitable hardware and/or software configuration, including, for example, modules executed on computing devices such as computing device 510 of FIG. 5. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 510 has one or more processing device 511 designed to process instructions, for example computer readable instructions (i.e., code) stored on a storage device 513. By processing instructions, processing device 511 may perform the steps set forth in the methods described herein. Storage device 513 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 510 additionally has memory 512, an input controller 516, and an output controller 515. A bus 514 operatively couples components of computing device 510, including processor 511, memory 512, storage device 513, input controller 516, output controller 515, and any other devices (e.g., network controllers, sound controllers, etc.). Output controller 515 may be operatively coupled (e.g., via a wired or wireless connection) to a display device 520 (e.g., a monitor, television, mobile device screen, touch-display, etc.) In such a fashion that output controller 515 can transform the display on display device 520 (e.g., in response to modules executed). Input controller 516 may be operatively coupled (e.g., via a wired or wireless connection) to input device 530 (e.g., mouse, keyboard, touch-pad, scroll-ball, touch-display, etc.) In such a fashion that input can be received from a user (e.g., a user may input with an input device 530 a dig ticket).

Of course, FIG. 5 illustrates computing device 510, display device 520, and input device 530 as separate devices for ease of identification only. Computing device 510, display device 520, and input device 530 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 510 may be one or more servers, for example a farm of networked servers, a clustered server environment, or a cloud network of computing devices.

While systems and methods are described herein by way of example and embodiments, those skilled in the art recognize that the systems and methods for improving call center efficiency are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A method for improving customer service efficiency, the method comprising:
receiving, by a computing device, information from a customer;
identifying, by a computing device, an issue based on the information received from the customer;
determining, by a computing device, whether a solution resolving the identified issue exists in a knowledge database that associates customer issues with known solutions, wherein the knowledge database includes information based on historical data, expert knowledge, one or more diagnostic techniques, and one or more language models;
if a solution to the identified issue exists in the knowledge database, reporting, by a computing device, the solution to the customer; and
if a solution to the identified issue does not exist in the knowledge database:
determining, by a computing device, an alternative solution based the information received from the customer;
determining, by a computing device, whether the alternative solution resolves the identified issue; and
if the alternative solution resolves the identified issue, updating, by a computing device, the knowledge database to associate the identified issue with the alternative solution.

2. The method of claim 1, wherein at least one of the diagnostic techniques utilizes a knowledge model based on information obtained through the use of one or more of a Bayesian model, a neural network, and a decision tree approach.

3. The method of claim 1, wherein the information within the knowledge database is organized into one or more classifications.

4. The method of claim 1, wherein the historical data includes information based on one or more previously identified issue and the effectiveness of one or more solutions applied to the previously identified issues.

5. The method of claim 1, further comprising developing, by a computing device, computer-executable code based on the knowledge database.

6. A system for improving customer service efficiency, the system comprising:
a computing device configured to receive information from a customer;
a computing device configured to identify an issue based on the information received from the customer;
a computing device configured to determine whether a solution resolving the identified issue exists in a knowledge database that associates customer issues with known solutions, wherein the knowledge database includes information based on historical data, expert knowledge, one or more diagnostic techniques, and one or more language models;
a computing device configured to report a solution to the customer if the solution to the identified issue exists in the knowledge database;
a computing device configured to determine an alternative solution based the information received from the customer if a solution to the identified issue does not exist in the knowledge database;
a computing device configured to determine whether the alternative solution resolves the identified issue if a solution to the identified issue does not exist in the knowledge database; and
a computing device configured to update the knowledge database to associate the identified issue with the alternative solution if the alternative solution resolves the identified issue.

7. The system of claim 6, wherein at least one of the diagnostic techniques utilizes a knowledge model based on information obtained through the use of one or more of a Bayesian model, a neural network, and a decision tree approach.

8. The system of claim 6, wherein the information within the knowledge database is organized into one or more classifications.

9. The system of claim 6, wherein the historical data includes information based on one or more issue previously identified and the effectiveness of solutions applied to the previously identified issues.

10. The system of claim 6, further comprising a computing device configured to develop computer-executable code based on the knowledge database.

11. Computer-readable code stored on a non-transitory computer-readable medium that, when executed by a mobile device, performs a method for improving customer service efficiency, the method comprising:
receiving, by a computing device, information from a customer;
identifying, by a computing device, an issue based on the information received from the customer;
determining, by a computing device, whether a solution resolving the identified issue exists in a knowledge database that associates customer issues with known solutions, wherein the knowledge database includes information based on historical data, expert knowledge, one or more diagnostic techniques, and one or more language models;
if a solution to the identified issue exists in the knowledge database, reporting, by a computing device, the solution to the customer; and
if a solution to the identified issue does not exist in the knowledge database:
determining, by a computing device, an alternative solution based the information received from the customer;
determining, by a computing device, whether the alternative solution resolves the identified issue; and
if the alternative solution resolves the identified issue, updating, by a computing device, the knowledge database to associate the identified issue with the alternative solution.

12. The computer-readable code of claim 11, wherein at least one of the diagnostic techniques utilizes a knowledge model based on information obtained through the use of one or more of a Bayesian model, a neural network, and a decision tree approach.

13. The computer-readable code of claim 11, wherein the information within the knowledge database is organized into one or more classifications.

14. The computer-readable code of claim 11, wherein the historical data includes information based on one or more issue previously identified and the effectiveness of solutions applied to the previously identified issues.

15. The computer-readable code of claim 11, wherein the method further comprises developing, by a computing device, computer-executable code based on the knowledge database.
